(19) United States
(12) Patent Application Publication
(10) Pub. No.: US 2018/0173745 A1
(43) Pub. Date: Jun. 21, 2018

(54) SYSTEMS AND METHODS TO ACHIEVE SEQUENTIAL CONSISTENCY IN REPLICATED STATES WITHOUT COMPROMISING PERFORMANCE IN GEO-DISTRIBUTED, REPLICATED SERVICES

(71) Applicant: AT&T Intellectual Property I, L.P., Atlanta, GA (US)

(72) Inventors: Bharath Balasubramanian, Belle Mead, NJ (US); Gerald Karam, Morristown, NJ (US); Kaustubh Joshi, Scotch Plains, NJ (US); Pamela Zave, Summit, NJ (US)

(21) Appl. No.: 15/387,178

(22) Filed: Dec. 21, 2016

(51) Int. Cl. G06F 17/30

(52) U.S. Cl. CPC G06F 17/30371; G06F 17/30581

(57) ABSTRACT

A system includes a plurality of sites a first plurality of key value data stores and a second plurality of key value stores. The first plurality of key value stores are provided with eventually consistent semantics for storing a plurality of keys. The second plurality of key value stores are provided with strongly consistent semantics for creating and storing locks created by a client. The system further includes a service for performing operations on the first plurality of key value store replicas and the second plurality of key value store replicas. the operations performed by the service conform to the following properties: when a client acquires a lock to a set of keys from the plurality of keys to create a set of locked keys, the client is guaranteed a consistent version that reflects a most recent update to each key in the set of locked keys; when the client performs reads and writes to the set of locked keys all reads and writes are ordered and other writers are excluded; and when a member key of the set of locked keys is unlocked, anyone can read and write to the member key, and values of member key replicas are eventually consistent.

### TECHNICAL FIELD

The present invention relates to distributed, client-server type computer networks that provide replicated services. More particularly, the present invention relates to computer networks which use a multi-site state-management tool combining an eventually consistent key-value store with a strongly consistent locking service that restricts access to the keys in the store.

### BACKGROUND

“State” includes all of the observable properties of a program and its environment, including instructions, variables, files, and input and output devices. In a distributed system, such as a network of workstations and servers, the overall state of the system is partitioned among several machines. The machines execute concurrently and mostly independently, each with immediate access to only a piece of the overall state. To access remote state, such as a memory location or device on a different machine, the requesting (or “client”) machine must send a message to the machine that contains the state (called the “server” for the request). Distributed state is information retained in one place that describes something, or is determined by something, somewhere else in the system. Only a small fraction of all the state in a distributed system is distributed state: information that describes something on one machine and is only used on that machine (e.g. saved registers for an idle process) is not distributed state.

Distributed state provides three benefits in a distributed system. These are performance, coherency, and reliability. Distributed state improves performance by making information available immediately avoiding the need to send a message to a remote machine to retrieve the information. Distributed state improves coherency. Machines need to agree on common goals and coordinate their actions to work together effectively. This requires each party to know something about the other. Distributed state improves reliability. If data is replicated at several sites in a distributed system and one of the copies is lost due to a failure, then it may be possible to use one of the other copies to recover the lost information.

The aforementioned benefits of distributed state are difficult to achieve in practice. That is because of the problems of sequential consistency, crash sensitivity, time and space overheads, and complexity. Sequential consistency problems arise when the same piece of information is stored at several places and one of the copies changes. Incorrect decisions may be made with the stale information if the other copies are not updated. Crash sensitivity is a problem because if one machine fails another machine can take over only if the replacement machine can recreate the exact state of the machine that failed. Time overheads arise in maintaining sequential consistency for example by checking consistency every time the state is used. Space overhead arises because of the need for storage of distributed copies of the same state. Finally, distributed state increases the complexity of systems.

Modern distributed services are often replicated across multiple sites/data-centers for reliability, availability and locality. In such systems, it is hard to obtain strong consistency and high availability since the replicas are often connected through the wide area network (WAN) where network partitions are much more common and the cost of achieving strong consistency through available protocols like Paxos (protocols for solving consensus in a network of unreliable processors) is very expensive due to high round trip delay time or round-trip time (RTT). This tension is captured by the CAP Theorem that states that replicated distributed services can either be CP (strongly consistent and partition tolerant) or AP (highly available and partition tolerant). Most prevalent distributed state-management tools force the service to make a strict choice between CP and AP semantics.

Most prevalent distributed state-management tools force the service to make a strict choice between CP and AP semantics. A large class of distributed key-value stores like Cassandra and MongoDB provide AP semantics, in that service replicas will respond even if they are partitioned, but one can read stale data, thereby compromising on strong consistency. On the other hand CP systems like Zookeeper, ensure that shared state is consistent across all service replicas, and the service maintains partition tolerance by becoming unresponsive when more than a majority of nodes goes down. Other CP systems achieve better performance features by relaxing the notion of consistency. For example COPS and Eiger ensure causal-consistency, while Google's Spanner isolates consistency mainly to shards of data. Since for multi-site services, the cost of CP solutions is exacerbated due to partitions and large RTTs, services needs the ability to use AP semantics for a majority of their operations and restrict the use of CP semantics.

There is a need to provide a multi-site state-management platform that allows services to flexibly choose between CP and AP semantics to manage a shared state.

### SUMMARY

A method includes providing a first plurality of key value store replicas with eventually consistent semantics for storing a plurality of keys wherein at least one of the first plurality of key value store replicas is situated in one of a plurality of sites. The method further includes providing a second plurality of key value store replicas with strongly consistent semantics for creating and storing locks created by a client wherein at least one of the second plurality of key value store replicas is situated in each of the plurality of sites. The method further includes performing operations on the first plurality of key value store replicas and the second plurality of key value store replicas whereby the operations conform the following properties: when a client acquires a lock to a set of keys from the plurality of keys to create a set of locked keys, the client is guaranteed a consistent version that reflects a most recent update to each key in the set of locked keys; when the client performs reads and writes to the set of locked keys all reads and writes are ordered and other writers are excluded; and when a member key of the set of locked keys is unlocked, anyone can read and write to the member key, and values of member key replicas are eventually consistent.

A system includes a plurality of sites, a first plurality of key value store replicas with eventually consistent semantics for storing a plurality of keys, wherein at least one of the first plurality of key value store replicas is situated in each site, and a second plurality of key value store replicas with strongly consistent semantics for creating and storing locks created by a client wherein at least one of the second plurality of key value store replicas is situated in each site. the system further includes a service for performing operations on the first plurality of key value store replicas and the second plurality of key value store replicas whereby the following properties are obtained by the service: when a client acquires a lock to a set of keys from the plurality of keys to create a set of locked keys, the client is guaranteed a consistent version that reflects a most recent update to each key in the set of locked keys; when the client performs reads and writes to the set of locked keys all reads and writes are ordered and other writers are excluded; and when a member key of the set of locked keys is unlocked, anyone can read and write to the member key, and values of member key replicas are eventually consistent.

A non-transitory computer readable storage medium storing a program configured for execution by a processor the program comprising instructions for providing a first plurality of key value store replicas with eventually consistent semantics for storing a plurality of keys wherein at least one of the first plurality of key value store replicas is situated in one of a plurality of sites. The program further comprising instructions for providing a second plurality of key value store replicas with strongly consistent semantics for creating and storing locks created by a client wherein at least one of the second plurality of key value store replicas is situated in each of the plurality of sites. The program further comprising instruction for performing operations on the first plurality of key value store replicas and the second plurality of key value store replicas whereby the operations conform to the following properties: when a client acquires a lock to a set of keys from the plurality of keys to create a set of locked keys, the client is guaranteed a consistent version that reflects a most recent update to each key in the set of locked keys; when the client performs reads and writes to the set of locked keys all reads and writes are ordered and other writers are excluded; and when a member key of the set of locked keys is unlocked, anyone can read and write to the member key, and values of member key replicas are eventually consistent.

### BRIEF DESCRIPTION OF THE DRAWINGS

FIG. 1 is a is a block diagram illustrating an exemplary network environment in which an embodiment of the present invention is utilized.

FIG. 2 is a pseudocode representation of a set of AP operations of an embodiment of the system.

FIG. 3 is a pseudocode representation of a set of CP operations of an embodiment of the system.

FIG. 4 is a pseudocode representation of an algorithm for creating a lock reference and releasing the lock in accordance with an embodiment.

FIG. 5 is a pseudocode representation of an algorithm for ensuring that in acquiring a lock no other value can overwrite the value of a locked key in a dataStore.

FIG. 6 is a pseudocode representation of an algorithm that ensures that the put and get operations maintain eventual consistent AP semantics.

FIG. 7 is a flow chart of the acquireLock process of an embodiment.

FIG. 8 is a pseudocode representation of a job scheduler in accordance with an embodiment.

FIG. 9 is a flowchart of a job scheduling process in accordance with an embodiment.

FIG. 10 is a pseudocode representation of a process for ensuring consistent state after fail over in accordance with an embodiment.

FIG. 11 is a pseudocode representation of a billing process in accordance with an embodiment.

FIG. 12 is a pseudocode representation of a replicated transaction manager that allows clients to execute a transactional batch of writes to a set of keys in accordance with an embodiment.

### DETAILED DESCRIPTION OF ILLUSTRATIVE EMBODIMENTS

Glossary

Abstraction is the act of representing essential features without including the background details or explanations and is used to reduce complexity and allow efficient design and implementation of complex software systems. Through the process of abstraction, a programmer hides all but the relevant data about an object in order to reduce complexity and increase efficiency.

Atomic Operations are program operations that run completely independently of any other processes.

Atomicity is a feature of databases systems dictating where a transaction must be all-or-nothing. That is, the transaction must either fully happen, or not happen at all. It must not complete partially.

CAP Theorem states that it is impossible for a distributed computer system to simultaneously provide all three of the following guarantees:
Consistency (every read receives the most recent write or an error)
Availability (every request receives a response, without guarantee that it contains the most recent version of the information)
Partition tolerance (the system continues to operate despite arbitrary partitioning due to network failures).

Computer-Readable Medium—any available media that can be accessed by a user on a computer system. By way of example, and not limitation, “computer-readable media” may include computer storage media and communication media. “Computer storage media” includes non-transitory volatile and nonvolatile, removable and non-removable media implemented in any method or technology for storage of information, such as computer-readable instructions, data structures, program modules or other data. “Computer storage media” includes, but is not limited to, RAM, ROM, EEPROM, flash memory or other memory technology; CD-ROM, digital versatile disks (DVD) or other optical storage devices; magnetic cassettes, magnetic tape, magnetic disk storage or other magnetic storage devices; or any other medium that can be used to store the desired information and that can be accessed by a computer. “Communication media” typically embodies computer-readable instructions, data structures, program modules or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media, such as a wired network or direct-wired connection, and wireless media, such as acoustic, RF, infrared and other wireless media. Combinations of any of the above should also be included within the scope of “computer-readable media.”

Critical section is a section of code for which a process obtains an exclusive lock so that no other process may execute it simultaneously. Often, one or more processes execute simultaneously in an operating system, forcing these processes to compete with each other for access to files and resources. Only one process should be allowed to access the resource while part of the code related to the resource is executed. To ensure that a process in the critical section does not fail while other processes are waiting, typically a time limit is set by the process management component. Thus, a process can have access to an exclusive lock for only a limited amount of time.

Eventual consistency is a consistency model used in distributed computing to achieve high availability that informally guarantees that, if no new updates are made to a given data item, eventually all accesses to that item will return the last updated value

Joins is an SQL operation performed to establish a connection between two or more database tables based on matching columns, thereby creating a relationship between the tables. Most complex queries in an SQL database management system involve join commands.

Key Value Store is a type of NoSQL database that doesn't rely on the traditional structures of relational database designs.

NoSQL is a class of database management systems (DBMS) that do not follow all of the rules of a relational DBMS and cannot use traditional SQL to query data.

Primitives. In computing, language primitives are the simplest elements available in a programming language. A primitive is the smallest ‘unit of processing’ available to a programmer of a given machine, or can be an atomic element of an expression in a language. Primitives are units with a meaning, i.e., a semantic value in the language. Thus they are different from tokens in a parser, which are the minimal elements of syntax.

Semantics means the ways that data and commands are presented. The idea of semantics is that the linguistic representations or symbols support logical outcomes.

Sequential consistency is a property that requires that “ . . . the result of any execution is the same as if the operations of all the processors were executed in some sequential order, and the operations of each individual processor appear in this sequence in the order specified by its program.” A system provides sequential consistency if every node of the system sees the (write) operations on the same memory part (page, cache line, virtual object, cell, etc.) in the same order, although the order may be different from the order in which operations are issued to the whole system. The sequential consistency is weaker than strict consistency, which requires a read from a location to return the value of the last write to that location; strict consistency demands that operations be seen in the order in which they were actually issued.

SQ—Structured Query Language (SQL) is a standard computer language for relational database management and data manipulation. SQL is used to query, insert, update and modify data. Most relational databases support SQL, which is an added benefit for database administrators (DBAs), as they are often required to support databases across several different platforms.

State, the state of a program is defined as its condition regarding stored inputs.

Strong Consistency is a protocol where all accesses are seen by all parallel processes (or nodes, processors, etc.) in the same order (sequentially). Therefore, only one consistent state can be observed, as opposed to weak consistency, where different parallel processes (or nodes, etc.) can perceive variables in different states.

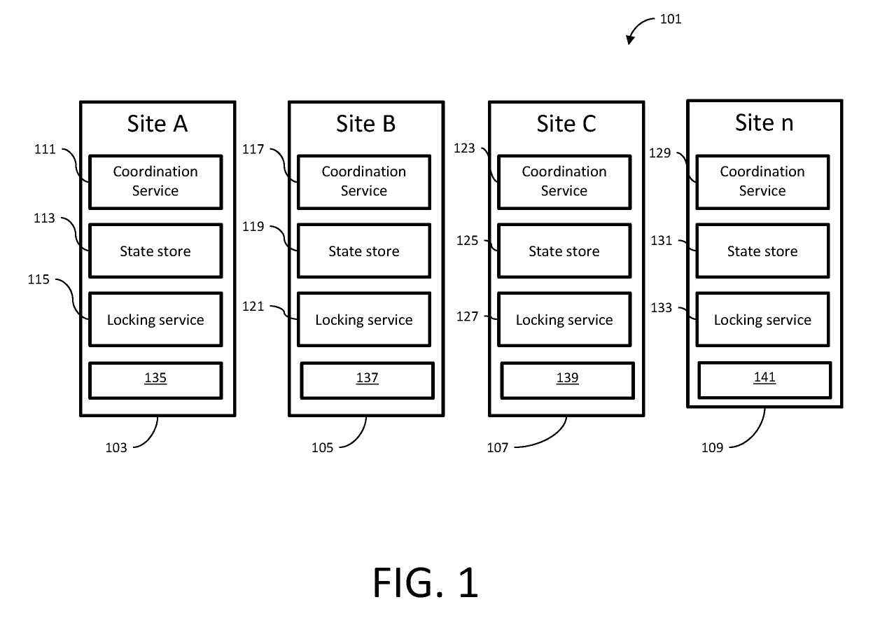

Illustrated in FIG. 1 is a system 101 comprising a plurality of sites, including site Site A 103, Site B 105, Site C 107, and Site n 109 that provide replicated services across the plurality of sites. Site A 103 is provided with a multiside coordination service (MCS 111), a key value state store 113, a distributed locking service 115 and may include program storage device 135. Site B 105 is provided with a multisite coordination service (MCS 117), a key value state store 119, a distributed locking service 121 and may include program storage device 137. Site C 103 is provided with a multisite coordination service (MCS 123), a key value state store 125, a distributed locking service 127 and may include program storage device 139. Site n 109 is provided with a multisite coordination service (MCS 129), a key value state store 131, a distributed locking service 133 and may include program storage device 141. MCS 111, MCS 117, MCS 123, and MCS 129) are referred to collectively as MCS. Key value state store 113, key value state store 119, state store key value 125, and key value state store 131 are referred to as the dataStores and each individually as a dataStore. Distributed locking service 115, distributed locking service 121, distributed locking service 127 and distributed locking service 133 are referred to as the lockStores and each individually as a lockStore. Program storage device 135, program storage device 137, program storage device 139 and program storage device 141 comprise Computer Readable Medium. A key-value store, or key-value database, is a data storage paradigm designed for storing, retrieving, and managing associative arrays, a data structure more commonly known today as a dictionary or hash. Dictionaries contain a collection of objects, or records, which in turn have many different fields within them, each containing data. These records are stored and retrieved using a key that uniquely identifies the record, and is used to quickly find the data within the database. The state of a computer program shows its current values or contents. The combination of a dataStore and a lockStore allow the service to enable fine-grained mutual exclusion at the granularity of the keys. This arrangement provides the ability to update shared state in a fully isolated, mutually exclusive manner that allows a service to toggle between strongly consistent and partition tolerant semantics (CP) and highly available and partition tolerant semantics (AP). To achieve the multi-site state management tool semantics guarantees are specified in terms of both consistency and availability. The guarantees are in force even one state transitions from CP to AP semantics, where some replicas might be accessing state using AP semantics while others are using CP semantics. The guarantees are achieved in a manner that is most efficient in terms of operational latency and throughput and scalable in terms of keys and sites.

The MCS runs as a distributed set of nodes, all executing the same algorithms (described below). Each MCS node also contains a replica of the dataStore and a replica of the lockStore.

The dataStores are replicated key-value stores with eventually consistent semantics that are used to store the key-value pairs created by the client. The dataStores satisfy the following requirements:
The dataStores provides two types of writes to each key. The writeOne(key,value) writes the value to the key at any one of the replicas, while the writeQuorum (key,value) writes to the majority of replicas. The values are eventually propagated to all the replicas.
Each write to the dataStores is associated with a timestamp and a tiebreaking writer identifier. Writes to each key are totally ordered by their timestamps, with the writer identifier being used to break ties when necessary.
Each key has a single value. The rule for composing updates is that the last write always wins. If there are no writes for a sufficient time, eventually all replicas will have the value of the last write.
The dataStores provide two read operations analogous to the writes in that the readOne(key) returns the value of the key at any one of the replicas, while the readQuorum(key) returns the latest value of the key among a majority of replicas.
For purposes of coordination, The dataStores provide a setLocalFlag (key) and resetLocalFlag (key) that allow each MCS node to maintain a flag purely at the local replica for a key. It also provides an allFlagsReset(key) that returns true if the local flags at all reachable MCS nodes have been reset. It also provides an allReplicasSame (key) which returns true only if the timestamp of the key value is the same at all reachable replicas.
   These properties are a version of Eventual Consistency in that there is no sequential ordering across the writes to a single key.

The lockStores satisfy the following requirements:
The lockStores are replicated key-value stores in which all writes to a key are totally ordered and the write order is determined by a consensus protocol such as Paxos or Raft. The value of a key is determined by the rule that the last write wins.
All replicas reflect a write before any replica reflects the next write. This means that a normal read of any replica gets either the last value written or the penultimate value written. There is also a special “synched” read guaranteed to get the last value written.
Each key has a pair of values assigned to it:
   lockStatus, with possible values of unLocked, beingLocked, or locked, can be updated using set (key, value) and read using get (key) operation. It is implemented with a normal read.
   lockHolder that implements a queue of objects used to order lock requests. The enQRequest(key) operation creates a request object with a unique reference and enqueues the object in the queue for the key. The deQRequest(key, reference) dequeues the reference object from the queue. There is also a peek (key) operation that returns the object at the top of the queue for the key, and is implemented with “synched” read.

FIG. 1 illustrates the design of the system 101 for an example of n replicas. The system 101 includes an ensemble of n replicas that represent the dataStores (key value state store 113, key value state store 119, key value state store 125 and key value state store 131) and n replicas that represent the lockStores (locking service 115, locking service 121, locking service 127, and locking service 133) and n nodes that represent the MCS (MCS 111, MCS 117, MCS 123, and MCS 129) each of which runs the algorithms described below. Each MCS replica interacts with the local (within site) dataStore and lockStore.

The MCS provides to its users or clients a replicated key-value store, where access to the keys can be controlled using locks. To use the MCS 111, a client issues a non-blocking request of its choice to a MCS node. The MCS node executes a single sequence of operations, in each of which it attempts to satisfy a client request, and reports success or failure back to the client.

In the dataStore, the MCS applies the semantics of replication that a key has a single correct value determined by the rule “last write wins.” The MCS attaches to each write request a timestamp and a tiebreaking node identifier. These (timestamp, tiebreaker) pairs establish the semantic order of writes, so that the value of any replica is the value of the latest-timestamped update it has received.

The system 101 described above implements a method comprising providing a first plurality of Key Value Store replicas with eventually consistent semantics for storing a plurality of keys wherein at least one of the first plurality of Key Value Store replicas is situated in one of a plurality of sites. The method further includes the step of providing a second plurality of Key Value Store replicas with strongly consistent semantics for creating and storing locks created by a client wherein at least one of the second plurality of Key Value Store replicas is situated in each of the plurality of sites. Finally the method includes performing operations on the first plurality of Key Value Store replicas and the second plurality of Key Value Store replicas whereby: when a client acquires a lock to a set of keys from the plurality of keys to create a set of locked keys, the client is guaranteed a consistent version that reflects a most recent update to each key in the set of locked keys; when the client performs reads and writes to the set of locked keys all reads and writes are ordered and other writers are excluded; and when a member key of the set of locked keys is unlocked, anyone can read and write to the member key, and values of member key replicas are eventually consistent.

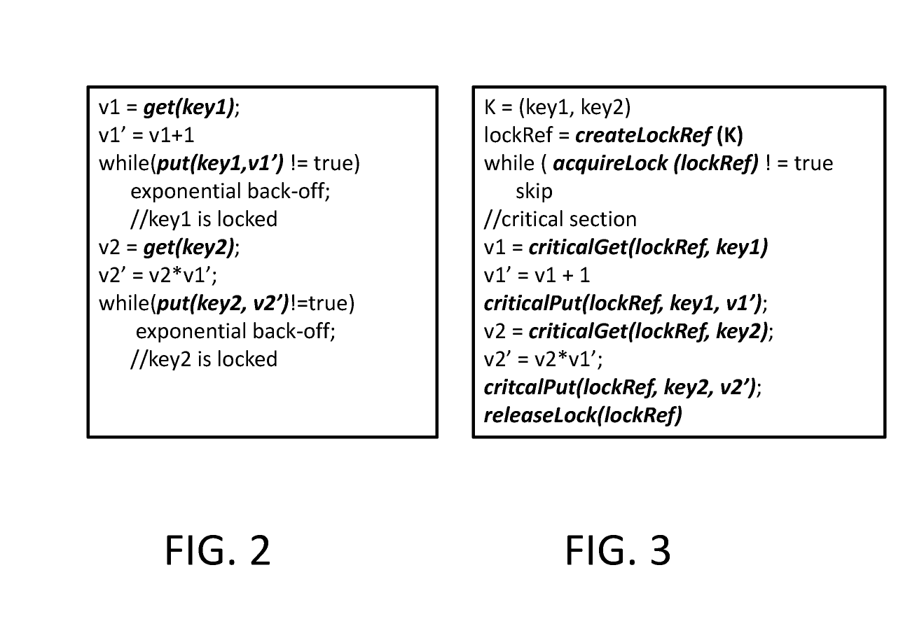

AP Operations. FIG. 2 is a pseudocode representation of a set of AP operations of an embodiment of the system. The code gets the value of key 1, modifies it, and puts the modified value back. It then repeats the process with key 2. The get and put operations of operate on a single node of the MCS and are hence partition-tolerant AP operations. TheMCS will get the value of a key for any client at any time. The value returned is the value of any replica. The MCS will accept a request to put (write) to a key at any time, but if the key is locked the request will fail (return false). The requestor should wait before retrying the put request, using the usual pattern of exponential back-off intervals. If the request succeeds, the new value will be written to at least one replica. Eventually, if there are no subsequent writes, the new value will propagate to all replicas. The AP operations are non-critical functions.

CP Operations. The operations of the MCS to create, acquire and release locks along and the corresponding reads and writes to the critical section operate on a majority of MCS nodes and are hence CP operations.

Using locks, a client can access the dataStore in a critical section with respect to one or more keys. The function createLockRef takes a set of keys and returns a lockRef, which is a ticket good for one critical section only. The lockRef acts as a unique identifier, authenticating the client as it makes its critical requests. The client then polls by executing acquireLock(lockRef) until it returns true, meaning that the client has been granted the locks and all the replicas of keys in the keyset have the correct (most recent) values.

The lock-holding client can then execute any number of criticalGet and criticalPut operations. These can be implemented as reads consulting a majority of replicas and writes to a majority of replicas. The implementation rule can also be generalized to reading r replicas and writing w replicas, where r+w is greater than the total number of replicas. During the critical section, any other client can still get the value of a key in the keyset. Finally, the client does releaseLock(lockRef) to end the critical section and allow other clients to hold the locks.

Critical Section guarantees. In a critical section the client holds locks to the keys, and enjoys two important properties:
Correct read: Any value that it reads is the value most recently written to the key.
Exclusive write: No other client can write to any of the keys.
   These properties guarantee Sequential Consistency and constrain who can write. To guarantee correct read and exclusive write, it is obviously necessary to prevent writes by other clients when one client holds a lock. It is also necessary to synchronize all the replicas of a key before granting a lock for the key, because if there are out-of-date replicas, then a read that misses some replicas might not get the correct value.

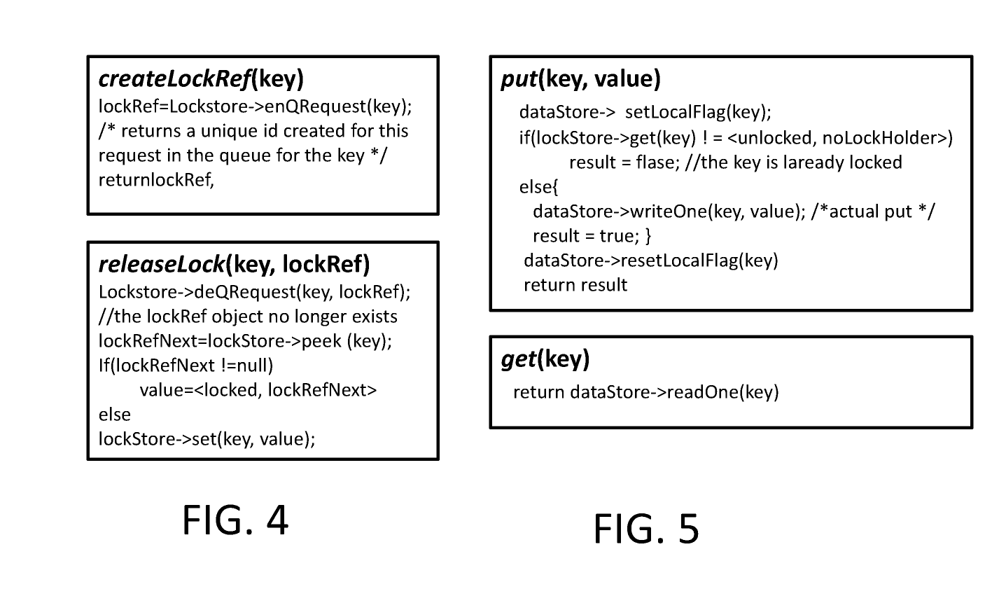

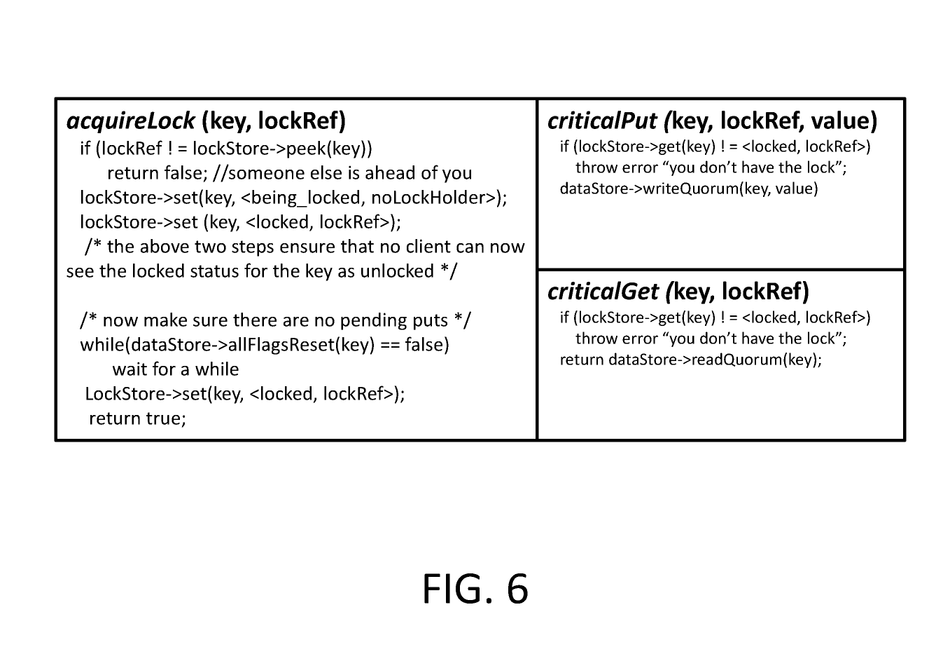

The MCS algorithms are designed on the principle that get and put, used by non-lockholding clients, should work even if there is only one MCS node (with its replicas of the dataStores) available. This means that the operations used to implement them must be local, and that get and put will be fast as well as fault-tolerant. At the same time, the put and acquireLock must be orchestrated to ensure that: (i) a client performing a put does not overwrite a locked key, and (ii) when granting a lock to a client, there must be no pending put that may overwrite the key's value. The pseudocodes for the algorithms, running on each node, are shown in FIGS. 4, 5, and 6.

The MCS locking abstractions are primarily built using the lockStores, where the queue for each key is used to maintain a total order among all lock requests. The value of the key in the lockStores is a tuple (lockStatus, lockHolder), where the lockStatus can be unLocked, being-Locked, or locked, and the lockHolder contains the lockRef of the client currently holding the lock (if any). Each time createLockRef is called, the lockStore creates and enqueues a newly created request object with a unique identifier in the queue for key and returns this identifier as the lockRef for this request. This is the reference used by the client for subsequent calls to acquire and use the lock. In releaseLock, the lockStore dequeues the request at the top of queue for key and grants the lock to the next request in the queue.

In execution of acquireLock, if the lockRef is at the top of the queue, then lockStore updates the tuple for the key twice, changing its status from unlocked to beingLocked and then locked. This ensures that no reader of the lock status can see it as unLocked. After these steps, before granting the lock to lockRef, the MCS ensures that there are no pending put operations to the key and there are no updates to the key in transit at its state store (due to the eventual propagation of previous puts). Once MCS ensures that the key has the same value at all the replicas of the state store, it grants the lock to lockRef. The criticalPut and criticalGet are only allowed for the current lockholder for a key and the functions use the dataStore operations to write and read from a majority of replicas respectively.

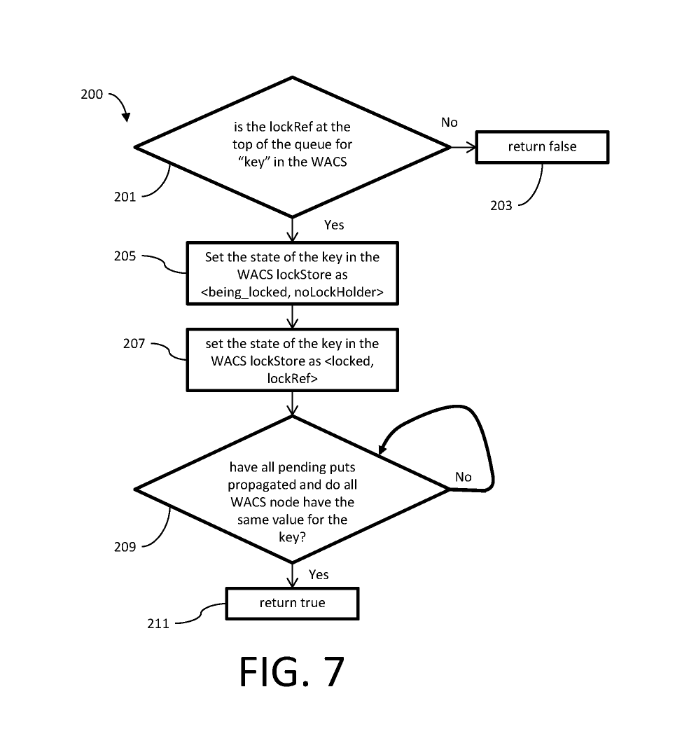

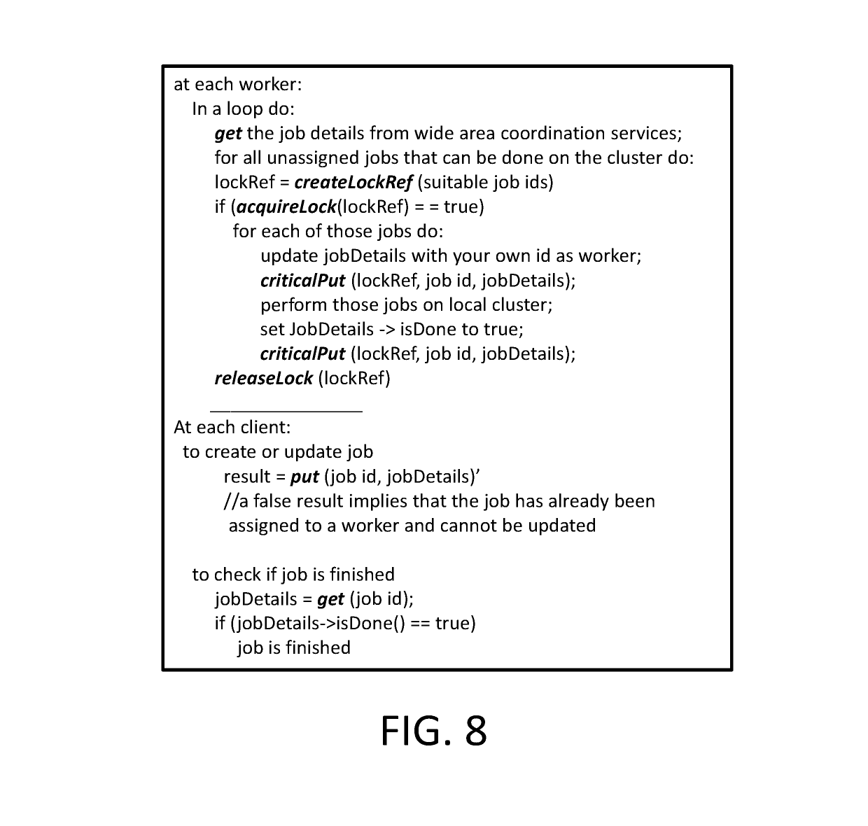

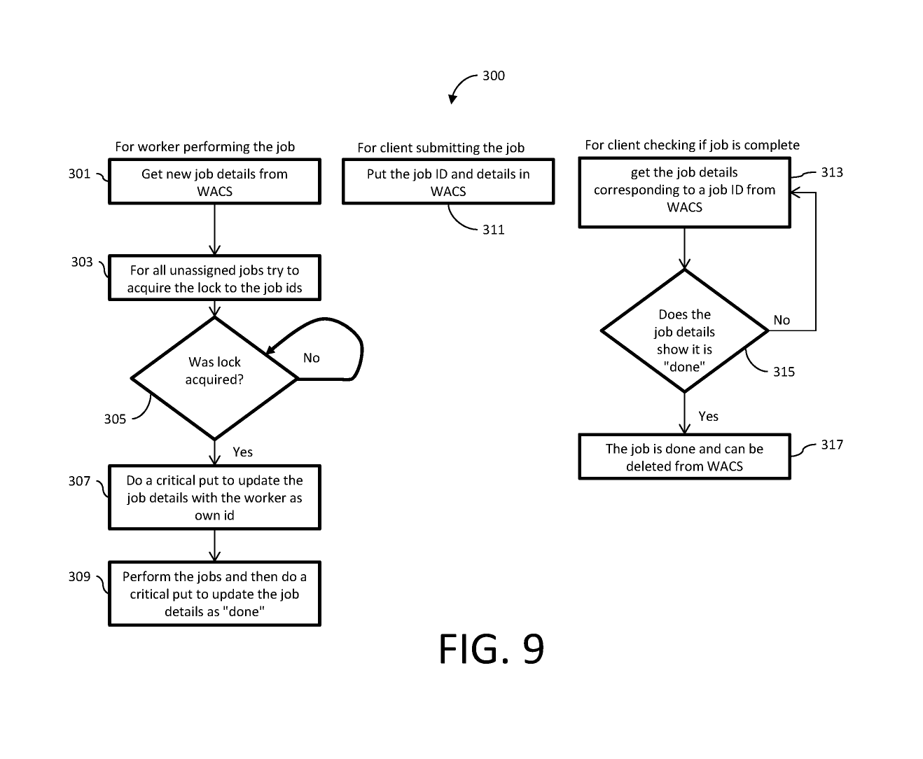

FIG. 7 is a flowchart of an acquireLock process 200 of an embodiment. In step 201 the process determines whether the lockRef is at the top of the queue for a key in the MCS. If the lockRef is not at the top of the queue for a key in the MCS the method returns false in step 203. If the lockRef is at the top of the queue for a key in the MCS the method in step 205 sets the state of the key in the MCS lockStore as <being locked, noLockHolder>. Thereafter the method in step 207 sets the state of the key in the MCS lockStore as <locked, lockRef>. In step 209 the method determines whether all pending puts have been propagated resulting in the MCS node having the same value for the key. If all pending puts have been propagated the method returns true in step 211.

The MCS put and get are the AP operations enabled for a client not holding the lock. In put, the dataStore sets its local flag for the key to indicate that a put operation is in progress. This ensures that another MCS replica trying to acquire the lock will see this flag and will wait until this put completes before granting the lock. Only after setting this flag does the put progress to check the lock status. If the key is unlocked, then the dataStore writes the value to any of the replicas and resets its local flag. The get simply returns the value of the key at any of the dataStore replicas.

The MCS nodes can detect crash and partition failures among each other, their subsystems, and clients accessing them. Clients too can detect failures in the MCS nodes they are accessing. While there is no limit on the number of distributed nodes or the clients accessing them, each MCS node executes as a single-threaded system with sequential operation.

All operations in these subsystems are assumed to be atomic operations despite replica failures. For example, if a dataStore writeQuorum returns true, this implies that a majority of the replicas have been updated; if it returns false, then it is guaranteed that no replica has been updated. All operations in the lockStore and dataStore are enabled as long as a majority of the replicas are alive and reachable. Furthermore, the dataStore readOne, writeOne, setLocalFlag, and resetLocalFlag are enabled even if just one of the replicas is alive and reachable. Importantly, the lockStore get is also enabled even if just one of the replicas is alive and reachable. All the subsystem operations apart from the local flag set and reset are durable and written to permanent storage.

A client communicating with a MCS node can detect the failure of that node and re-issue its command to another MCS node. This will have the same effect on the dataStore as the original command, unless a later timestamp changes its effect.

Failure in a MCS node can leave a key in the lockStore in an intermediate state that can result in starvation for clients trying to acquire the lock for that key. For example, if a MCS node fails after executing the lockStore→enQRequest in a createLockRef call, then no subsequent client can acquire the lock until that lockRef is deleted from the queue. Similarly, failure during an acquireLock can result in an intermediate value for the key in the lockStore. These concerns are addressed by associating a client-provided timeout value for each lock, which signifies the maximum amount of time for which any lock can be held by a client. The MCS replicas run a garbage collection thread that periodically checks the lockStore for the lock times and resets the state of the lock to (unLocked, noLockHolder).

Failure in a client accessing MCS has implications only if the client dies while holding a lock to a key. As mentioned above, each lock is associated with a timeout and MCS will eventually release a lock that was held by the failed client. Since MCS can detect failure of a client accessing the system, client failure could be detected more eagerly and the lock could be released immediately after failure.

### EXAMPLE 1

Mutual exclusion over replicated state. When multiple writers are trying to access replicated state it is possible that some of the writers will require CP semantics while others need AP semantics. An example may be a job scheduler to which clients submit and update jobs, each of which is performed by a worker managing its own site resources. In this example the jobs may be cloud deployment templates which can deployed by a worker on its own site based on resource availability. This scheduler can be implemented as a multi-site replicated system with a scheduler replica on each site for reliability, locality and availability. These replicas maintain the shared state of job details that includes the worker a job has been assigned to.

In such systems, to avoid wastage of cloud resources, it is important that two workers never deploy the same cloud template. Hence, the job-worker mapping need to be updated in a sequentially consistent manner using CP semantics. On the other hand, a client submitting and updating jobs only requires AP semantics since this information can be eventually consistent until the job is assigned to a worker.

This can be achieved by the MCS pseudocode illustrated in FIG. 7. Clients can submit and update jobs to a scheduler replica closest to them by using the put operation that will function even under network partitions due to its AP semantics.

Workers can periodically read the job details off a scheduler replica, and try to acquire locks to unassigned jobs that they wish to perform. Then they can assign themselves to the jobs for which they have been granted the lock. The MCS properties guarantee that the workers have exclusive access to the replicated job details. The tight integration between the locks and the state also ensures that a client can never update the details of a job that has already been picked by a worker.

### EXAMPLE 2

Load-balanced active-passive replication. One of the most common modes of replication in distributed systems is to maintain an ensemble of service replicas where each replica serves two roles: it acts as a primary/active for a subset of client requests and it also acts as a backup for a subset of other client requests. An example may be a multi-site load-balanced media server, which hosts customer conference calls. Each media-server acts as the active server for some conference calls and as the passive for others, wherein when the active server for a call fails, one of its passive servers can take over operation so that the call can continue, relatively uninterrupted. For each call, the media server maintains state that contains the call details such as the end points/users in the call. To enable fast failover, the call information is replicated at each backup server.FIG.

During normal operation when conference calls are being setup, updated and broken, the media server should be able to update shared state using AP semantics. However, when one of the media servers fail, two activities need to happen. First, one of its passive servers needs to take over the call and second, the new active server must obtain a consistent view of the call details that it is taking over. In other words, the new active server needs CP semantics during failure.

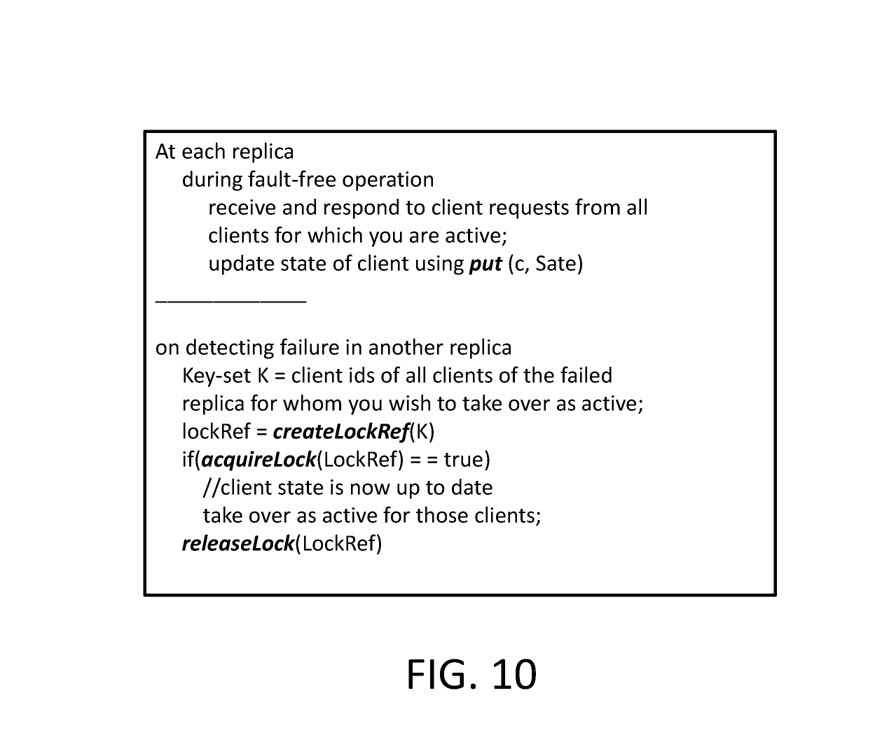

As shown in FIG. 10 this problem may be addressed by the MCS since the replicas can store the state of the client. This ensures that state is replicated across all the replicas and hence failover can be fast. During normal operation the replicas can access and update this state using the MCS AP operations since each client is managed by only one replica.

During failure, MCS solves two subtle but crucial problems in such a replicated setup: load redistribution and consistent state. When a replica dies, other replicas who wish to take over the load of this current replica can simply acquire locks to the clients they are interested in serving (based on locality, availability of resources etc.) and take over as the active for the these clients. The MCS semantics guarantee that only one of the replicas will succeed in acquiring the lock and hence there will be only one new active for the client requests. This enables load-redistribution without a central authority coordinating the activity. MCS also ensures that by virtue of acquiring a lock to a client, the new replica has the most up to date version of the state.

### EXAMPLE 3

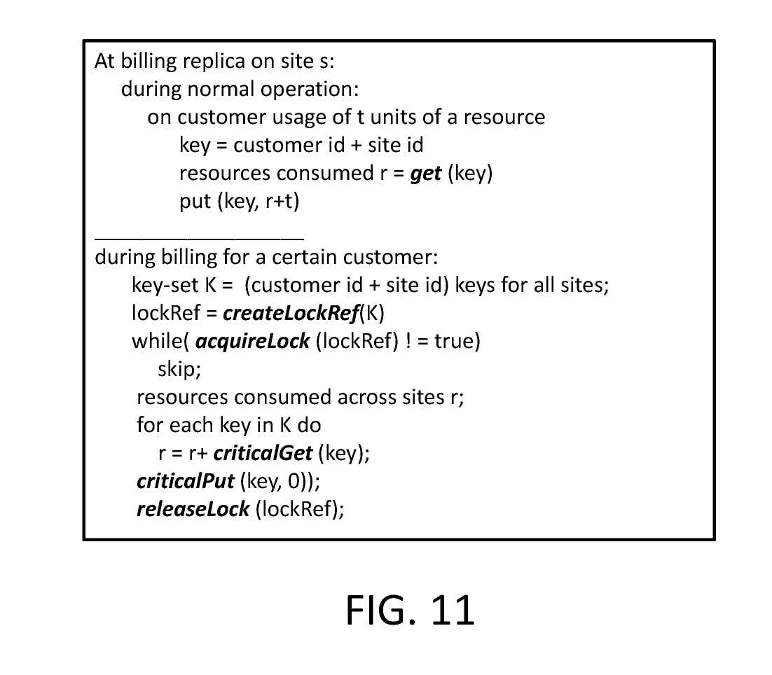

Barriers over distributed state. Barriers are often used to synchronize replicated state to get a consistent view of data. The challenging part is to allow AP semantics to update state during normal operation and use CP semantics only when a barrier is required. A common example of this coordination pattern is distributed billing. Consider a multi-site distributed service that tracks customer usage of a certain resources (such as virtual machines) across sites. This information can be maintained with the keys being a combination of the customer and site (See the pseudocode at FIG. 11). At each site, whenever a customer uses the resource, a billing-replica uses AP operations to read and increment the billing information. Since the site-specific information is unique to that site and accessed by only one replica, there is no need for stronger CP semantics. However, when one of the replicas needs to do billing for a customer, it can simply acquire a lock to all his/her keys across the sites, aggregate them and then reset those values. The lock ensures that the site information cannot be updated until the billing is done.

### EXAMPLE 4

Data-store patterns for strong semantics. MCS can be used to build strong data semantics over state maintained in an eventually consistent store. Many eventually consistent data stores like Cassandra provide a Structured Query Language (SQL)-like interface to help applications transition relatively smoothly from standard databases to these keyvalue stores. However, they do not provide a fundamental SQL Primitive: the ability to perform consistent Joins across keys stored in different tables. MCS with Cassandra as its data store can be used to build this abstraction through the following steps: (i) acquire a lock to the keys across different tables, (ii) generate the cross product of (key, value) pairs across both these tables, and finally (iii) apply the search query filters on this cross-product.

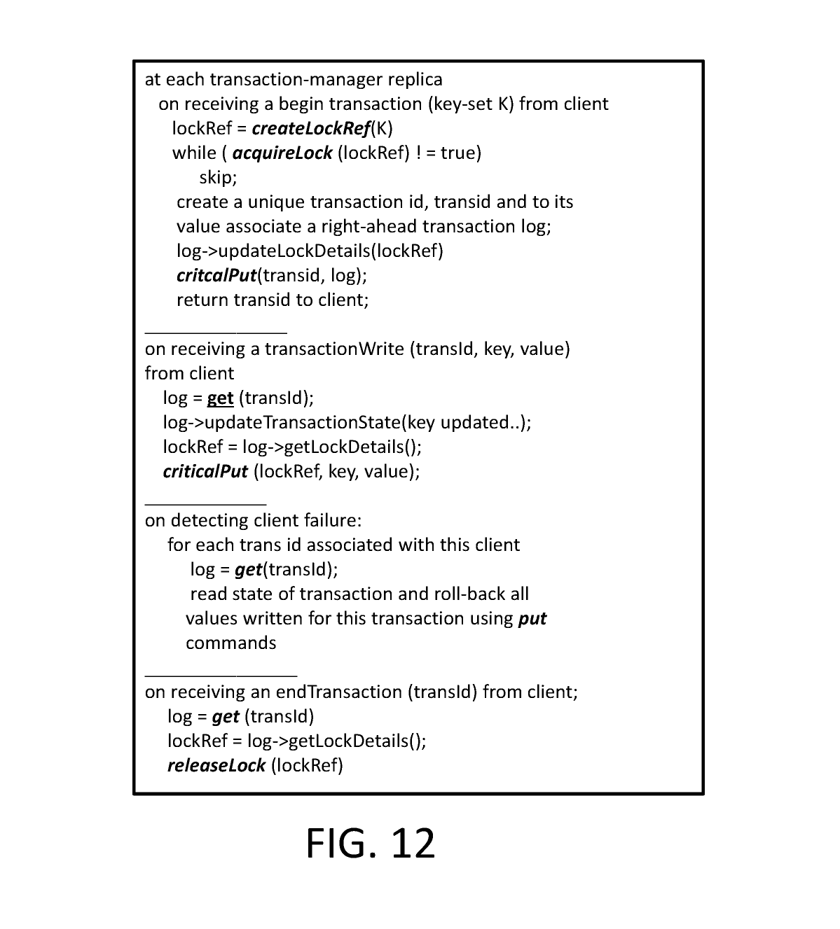

While operations performed after acquiring a MCS lock are atomic, strongly consistent, and durable (written to permanent storage), for many use cases, it can be very useful to have a transactional set of operations that guarantee the standard ACID (Atomicity, Consistency, Isolation, Durability) features provided by databases. This can be achieved through a combination of locks and roll-back protocols (See pseudocode in FIG. 12). An example is a replicated transaction manager that allows clients to execute a transactional batch of writes to a set of keys. In FIG. 10 we describe the code at every replica on receiving calls from a client executing a transaction. The transaction manager creates a unique transaction id for each client transaction and associates a write ahead log for this transaction in MCS. To begin a transaction, the manager first acquires a lock to all the keys in the transaction and for each subsequent read and write received from a client that belong to this transaction, the manager writes to MCS and updates the log. On failure of the client, the manager can simply read the log off MCS and roll-back all the updates. When a manager fails, since the manager maintains all state in MCS, the client can simply redirect the transaction calls to another manager replica.

An embodiment also provides a program storage device (e.g. storage device 135, storage device 137, storage device 139 or storage device 141 in FIG. 1) comprising non-transitory Computer Readable Medium readable by a computer or other machine, embodying a program of instructions executable by the machine to perform the various aspects of the method as discussed and claimed herein, and as illustrated in the Figures, for performing the various functional aspects of the method as set forth herein. Generally speaking, the program storage device 135, program storage device 137, program storage device 139 and program storage device 141 may be implemented using any technology based upon materials having specific magnetic, optical, or semiconductor properties that render them suitable for storing computer data, whether such technology involves either volatile or non-volatile storage media. Specific examples of such media can include, but are not limited to, magnetic hard or floppy disks drives, optical drives or CD-ROMs, and any memory technology based on semiconductors or other materials, whether implemented as read-only or random access memory. In short, this embodiment of the invention may reside either on a medium directly addressable by the computer's processor (main memory, however implemented) or on a medium indirectly accessible to the processor (secondary storage media such as hard disk drives, tape drives, CD-ROM drives, floppy drives, or the like). Consistent with the above teaching, program storage device 135, 137, 139 and 141 can be affixed permanently or removably to a bay, socket, connector, or other hardware provided by the cabinet, motherboard, or other component of a given computer system.

For the purpose of conciseness, and in the interest of avoiding undue duplication of elements in the drawings, only FIG. 1 shows the program storage devices 135, 137, 139 and 141. However, those skilled in the art will recognize that an application program stored on program storage device 135 could implement all functionality illustrated in any of the drawings or discussed anywhere in the description.

It will be appreciated by those of ordinary skill having the benefit of this disclosure that the illustrative embodiments described above are capable of numerous variations without departing from the scope and spirit of the invention. Various modifications and changes may be made as would be obvious to a person skilled in the art having the benefit of this disclosure. It is intended that the following claims be interpreted to embrace all such modifications and changes and, accordingly, the specifications and drawings are to be regarded in an illustrative rather than a restrictive sense.

What is claimed:

1. A method comprising:
providing a first plurality of key value store replicas with eventually consistent semantics for storing a plurality of keys wherein at least one of the first plurality of key value store replicas is situated in one of a plurality of sites;
providing a second plurality of key value store replicas with strongly consistent semantics for creating and storing locks created by a client wherein at least one of the second plurality of key value store replicas is situated in each of the plurality of sites;
performing operations on the first plurality of key value store replicas and the second plurality of key value store replicas whereby:
when a client acquires a lock to a set of keys from the plurality of keys to create a set of locked keys, the client is guaranteed a consistent version that reflects a most recent update to each key in the set of locked keys;
when the client performs reads and writes to the set of locked keys all reads and writes are ordered and other writers are excluded; and
when a member key of the set of locked keys is unlocked, anyone can read and write to the member key, and values of member key replicas are eventually consistent.

2. The method of claim 1 wherein the first plurality of key value store replicas provide a first type of write that writes a value to one of the plurality of keys at any one first plurality of key value store replicas and a second type of write that writes to a majority of the plurality of keys in the first plurality of key value store replicas.

3. The method of claim 2 wherein the first type of write and the second type of write is associated with a timestamp and a writer identifier whereby writes to each of the plurality of keys are totally ordered by a timestamp, with the writer identifier being used to break ties when necessary.

4. The method of claim 1 wherein the first plurality of key value store replicas provide a first type of read that returns a value of one of the plurality of keys at any one of the first plurality of key value store replicas and a second type of read that returns a latest value of one of the plurality of keys among a majority of the first plurality of key value store replicas.

5. The method of claim 1 wherein all writes to the second plurality of key value store replicas are totally ordered in a write order and the write order is determined by a consensus protocol.

6. The method of claim 1 wherein all of the second plurality of key value store replicas reflect a write before any of the second plurality of key value store replicas reflects a next write.

7. The method of claim 1 wherein each of the plurality of keys are assigned a value lockStatus, with possible values of unLocked, beingLocked, or locked, and that can be updated using set (key, value) and read using get (key) operation.

8. A system comprising:
a plurality of sites;
a first plurality of key value store replicas with eventually consistent semantics for storing a plurality of keys, wherein at least one of the first plurality of key value store replicas is situated in each site;
a second plurality of key value store replicas with strongly consistent semantics for creating and storing locks created by a client wherein at least one of the second plurality of key value store replicas is situated in each site; and
a service for performing operations on the first plurality of key value store replicas and the second plurality of key value store replicas whereby:
when a client acquires a lock to a set of keys from the plurality of keys to create a set of locked keys, the client is guaranteed a consistent version that reflects a most recent update to each key in the set of locked keys;
when the client performs reads and writes to the set of locked keys all reads and writes are ordered and other writers are excluded; and
when a member key of the set of locked keys is unlocked, anyone can read and write to the member key, and values of member key replicas are eventually consistent.

9. The system of claim 8 wherein the first plurality of key value store replicas provide a first type of write that writes a value to one of the plurality of keys at any one first plurality of key value store replicas and a second type of write that writes to a majority of the plurality of keys in the first plurality of key value store replicas.

10. The system of claim 9 wherein the first type of write and the second type of write is associated with a timestamp and a writer identifier whereby writes to each of the plurality of keys are totally ordered by a timestamp, with the writer identifier being used to break ties when necessary.

11. The system of claim 8 wherein the first plurality of key value store replicas provide a first type of read that returns a value of one of the plurality of keys at any one of the first plurality of key value store replicas and a second type of read that returns a latest value of one of the plurality of keys among a majority of the first plurality of key value store replicas.

12. The system of claim 8 wherein all writes to the second plurality of key value store replicas are totally ordered in a write order and the write order is determined by a consensus protocol.

13. The system of claim 8 wherein all of the second plurality of key value store replicas reflect a write before any of the second plurality of key value store replicas reflects a next write.

14. The system of claim 8 wherein each of the plurality of keys are assigned a value lockStatus, with possible values of unLocked, beingLocked, or locked, and that can be updated using set (key, value) and read using get (key) operation.

15. A non-transitory computer readable storage medium storing a program configured for execution by a processor the program comprising instructions for:
providing a first plurality of key value store replicas with eventually consistent semantics for storing a plurality of keys wherein at least one of the first plurality of key value store replicas is situated in one of a plurality of sites;
providing a second plurality of key value store replicas with strongly consistent semantics for creating and storing locks created by a client wherein at least one of the second plurality of key value store replicas is situated in each of the plurality of sites;
performing operations on the first plurality of key value store replicas and the second plurality of key value store replicas whereby:
when a client acquires a lock to a set of keys from the plurality of keys to create a set of locked keys, the client is guaranteed a consistent version that reflects a most recent update to each key in the set of locked keys;
when the client performs reads and writes to the set of locked keys all reads and writes are ordered and other writers are excluded; and
when a member key of the set of locked keys is unlocked, anyone can read and write to the member key, and values of member key replicas are eventually consistent.

16. The non-transitory computer readable storage medium of claim 15 wherein the first plurality of key value store replicas provide a first type of write that writes a value to one of the plurality of keys at any one first plurality of key value store replicas and a second type of write that writes to a majority of the plurality of keys in the first plurality of key value store replicas.

17. The non-transitory computer readable storage medium of claim 16 wherein the first type of write and the second type of write is associated with a timestamp and a writer identifier whereby writes to each of the plurality of keys are totally ordered by a timestamp, with the writer identifier being used to break ties when necessary.

18. The non-transitory computer readable storage medium of claim 15 wherein the first plurality of key value store replicas provide a first type of read that returns a value of one of the plurality of keys at any one of the first plurality of key value store replicas and a second type of read that returns a latest value of one of the plurality of keys among a majority of the first plurality of key value store replicas.

19. The non-transitory computer readable storage medium of claim 15 wherein all of the second plurality of key value store replicas reflect a write before any of the second plurality of key value store replicas reflects a next write.

20. The non-transitory computer readable storage medium of claim 15 wherein each of the plurality of keys are assigned a value lockStatus, with possible values of unLocked, beingLocked, or locked, and that can be updated using set (key, value) and read using get (key) operation.
